(19) United States
(12) Patent Application Publication
(10) Pub. No.: US 2011/0285643 A1
(43) Pub. Date: Nov. 24, 2011

(54) OPTICAL TOUCH DISPLAY DEVICE

(75) Inventors: Chih-Hung Lu, Hsinchu (TW); Hui-Hsuan Chen, Hsinchu (TW); Wei-Chung Wang, Hsinchu (TW)

(73) Assignee: PixArt Imaging Inc., Hsinchu (TW)

(21) Appl. No.: 12/940,590

(22) Filed: Nov. 5, 2010

Related U.S. Application Data
(60) Provisional application No. 61/347,404, filed on May 22, 2010.

(30) Foreign Application Priority Data
Aug. 25, 2010 (TW) 099128534

(51) Int. Cl. G06F 3/041

(52) U.S. Cl. 345/173

(57) ABSTRACT

An optical touch display device includes a display unit and at least one light sensing module. The display unit includes a first substrate and a display layer. The first substrate has a display area and a non-display area surrounding the display area. The display layer is disposed on the display area of the first substrate. The light sensing module is disposed on an upper surface of the non-display area of the first substrate. A side surface of the light sensing module has a light sensing window, and at least a portion of the light sensing window is adapted to receive light above the display unit. The optical touch display device has a thin thickness.

### CROSS-REFERENCE TO RELATED APPLICATIONS

This application is based upon and claims the benefit of priority from the prior U.S. Provisional Patent Application No. 61/347,404, filed May 22, 2010, the entire contents of which are incorporated herein by reference.

### FIELD OF THE INVENTION

The present invention relates to a touch display device, and more particularly to an optical touch display device.

### BACKGROUND OF THE INVENTION

Touch display devices are easily operated, so that the touch display devices have been widely used in many electronic products, such as mobile phones, personal digital assistants (PDA), digital cameras, music players, computers, satellite navigation devices and so on.

Currently, common touch display devices include resistive touch display devices, capacitive touch display devices and optical touch display devices. The optical touch display devices are received more and more attention due to having an advantage of low cost.

FIG. 1 is a schematic view of a conventional optical touch display device. Referring to FIG. 1, a conventional optical display device 100 includes a liquid crystal display unit 110, a touch unit 120 and a transparent substrate 130. The liquid crystal display unit 110 includes a lower substrate 111, an upper substrate 112, a liquid crystal layer 113, a backlight source 114 and a frame 115. The liquid crystal layer 113 is disposed between the lower substrate 111 and the upper substrate 112, and the liquid crystal layer 113, the lower substrate 111 and the upper substrate 112 collectively constitute a liquid crystal display panel 116. The backlight source 114 is disposed under the liquid crystal display panel 116, and is configured to provide display light for the liquid crystal display panel 116. The frame 115 is configured to fix the liquid crystal display panel 116 and the backlight source 114. In addition, the transparent substrate 130 is disposed on the frame 115 and is located above the liquid crystal layer 113. The touch unit 120 is disposed on the transparent substrate 130. The touch unit 120 includes a light source 122 and a light sensing module 124. The light source 122 is configured to provide light 123, and the light sensing module 124 is configured to receive the light 123 provided by the light source 122.

The light sensing module 124 has a plurality of photosensitive pixels so as to detect the light 123. When a user operates the touch unit 120, a transmitting path of a portion of light 123 is changed, so that a portion of the photosensitive pixels do not detect the light 123. Therefore, a touch position can be calculated according to the photosensitive pixels that have not detected the light 123.

In the conventional technology, because the touch unit 120 is disposed on the transparent substrate 130, the overall thickness of the optical touch display device 100 is thick.

### SUMMARY OF THE INVENTION

The present invention provides an optical touch display device which has a thin thickness.

To achieve the above-mentioned advantage, the present invention provides an optical touch display device includes a display unit and at least one light sensing module. The display unit includes a first substrate and a display layer. The first substrate has a display area and a non-display area surrounding the display area. The display layer is disposed on the display area of the first substrate. The light sensing module is disposed on an upper surface of the non-display area of the first substrate. A side surface of the light sensing module has a light sensing window, and at least a portion of the light sensing window is adapted to receive light above the display unit.

In one embodiment of the present invention, the light sensing module includes a sensing unit and a fixing unit. The sensing unit is fixed above the non-display area of the first substrate via the fixing unit and the fixing unit elevates the sensing unit to above the display unit. Thereby, the sensing unit is capable of detecting the light above the display unit via the at least a portion of the light sensing window and outputting a sensing signal.

In one embodiment of the present invention, the side surface having the light sensing window abuts the display layer, and the side surface having the light sensing window and the light sensing window are perpendicular to the first substrate.

In one embodiment of the present invention, the light sensing module further includes a lens unit and a circuit board. The lens unit is configured to provide the light from the light sensing window to the sensing unit. The circuit board is electrically connected to the sensing unit and configured to output the sensing signal output by the sensing unit. The lens unit and the sensing unit are fixed to the first substrate via the fixing unit and the fixing unit elevates the lens unit and the sensing unit to behind the light sensing window, and thereby the sensing unit is capable of detecting the light passing through the light sensing window and above the display unit via the lens unit.

In one embodiment of the present invention, the fixing unit further fixes the circuit board.

In one embodiment of the present invention, the optical touch display device includes a plurality of the light sensing modules. The display area is a rectangle, and the light sensing modules are respectively disposed on corners of the display area.

In one embodiment of the present invention, the sensing unit has a plurality of sensing areas, and each sensing area has a field of view. The light sensing module further includes at least one reflecting element disposed in front of at least one of the sensing areas so as to turn the field of view of the corresponding sensing area.

In one embodiment of the present invention, the reflecting element comprises a prism.

In one embodiment of the present invention, the optical touch display device further includes a light source. The light source is disposed on the non-display area of the first substrate and provides the light passing through an area above the display layer to the light sensing module.

In one embodiment of the present invention, the light source further includes at least one light emitting element and at least one light guiding element. The light emitting element is configured to provide the light. The light guiding element is disposed beside the light emitting element. The light emitting element has a light incident surface and a light emitting surface. The light incident surface is configured to receive the light, and the light is emitted from the light emitting surface.

In one embodiment of the present invention, the light emitting element includes an infrared light emitting element.

In one embodiment of the present invention, the optical touch display device further includes a frame, and the display unit and the light sensing module are partially wrapped in the frame.

In one embodiment of the present invention, the display unit further includes a second substrate and a plurality of spacers. The second substrate is opposite to the first substrate, and the display layer is disposed between the first substrate and the second substrate. The spacers are disposed between the first substrate and the second substrate.

In one embodiment of the present invention, the display unit further includes a backlight source disposed under the first substrate.

In one embodiment of the present invention, the display unit includes a liquid crystal display unit, a bistable display unit, an organic light-emitting diode display unit, an electrowetting display unit or a plasma display unit.

In the present invention, the light sensing module is disposed on the first substrate supporting the display layer, but is not disposed on the entire display unit. Furthermore, compared to the conventional techniques, the light sensing module of the present invention omits a transparent substrate disposed above the display unit. Therefore, the optical touch display device of the present invention has a thin thickness.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is a schematic view of a conventional optical touch display device.

FIG. 2 is a schematic view of an optical touch display device according to an embodiment of the present invention.

FIG. 3 is a schematic view of an optical touch display device according to another embodiment of the present invention.

FIG. 4 is a schematic, top view of an optical touch display device according to another embodiment of the present invention.

FIG. 5 is a schematic view of an optical touch display device according to another embodiment of the present invention.

FIG. 6 is a schematic view of a light sensing module of an optical touch display device according to another embodiment of the present invention.

FIG. 7 is a schematic view of an optical touch display device according to another embodiment of the present invention.

FIG. 8 is a schematic, top view of an optical touch display device according to another embodiment of the present invention.

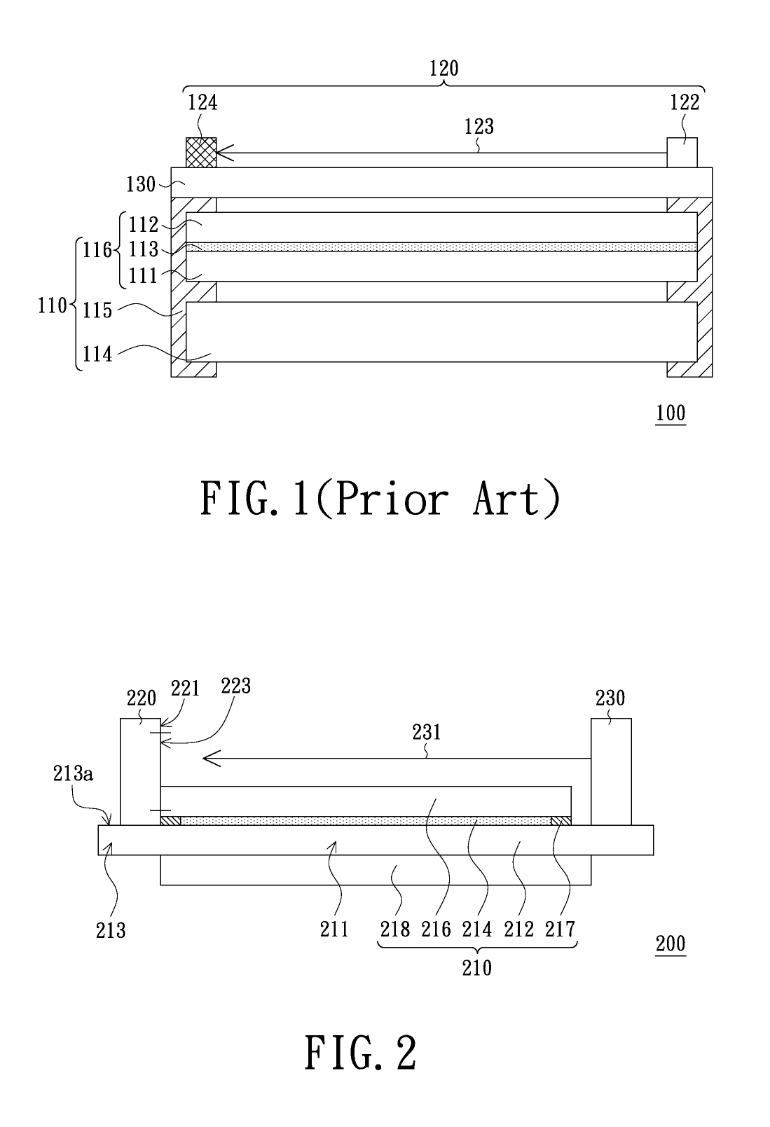

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

FIG. 2 is a schematic view of an optical touch display device according to an embodiment of the present invention. Referring to FIG. 2, an optical touch display device 200 of the present embodiment includes a display unit 210 and at least one light sensing module 220. The display unit 210 includes a first substrate 212 and a display layer 214. The first substrate layer 212 has a display area 211 and a non-display area 213 surrounding the display area 211. The display layer 214 is disposed on the display area 211 of the first substrate 212. The light sensing module 220 is disposed on an upper surface 213a of the non-display area 213 of the first substrate 212. A side surface 221 of the light sensing module 220 has a light sensing window 223, wherein at least a portion of the light sensing window 223 is adapted to receive light 231 above the display unit 210.

The side surface 221 having the light sensing window 223, for example, abuts the display layer 214, and the side surface 221 having the light sensing window 223 and the light sensing window 223 are, for example, perpendicular to the first substrate 211. Additionally, the above-mentioned display unit 210 can be a liquid crystal display unit, a bistable display unit, an organic light-emitting diode display unit, an electrowetting display unit, a plasma display unit or other types of display unit, and FIG. 2 takes the liquid crystal unit for example. The display unit 210 may further include a second substrate 216 and a plurality of spacers 217. The second substrate 216 is opposite to the first substrate 212, and the display layer 214 is disposed between the first substrate 212 and the second substrate 216. The spacers 217 are disposed between the first substrate 212 and the second substrate 216. That is, the spacers 217 and the display layer 214 are disposed on a same layer. The spacers 217 are used to maintain the space between the first substrate 212 and the second substrate 216.

In the present embodiment, since a portion of the light sensing window 223 is sheltered by the second substrate 216, only another portion of the light sensing window 223 can receive the light 231 above the display unit 210. In addition, since the display layer 214 of the liquid crystal display unit 210 is a non-self-luminous display layer, the display unit 210, for example, further includes a backlight source 218 disposed under the first substrate 212, so as to provide display light for the display layer 214. Moreover, in alternative embodiments that the display layer is a self-luminous display layer, the backlight source 218 can be omitted.

The above-mentioned optical touch display device 200 may further include a light source 230. The light source 230 is disposed on the non-display area 213 of the first substrate 212 and provides the light 231 passing through an area above the display layer 214 to the light sensing module 220. The light 231 provided by the light source 230 is, for example, but not limited, infrared light. In addition, after the light 231 enters the light sensing module 220 via the light sensing window 223, at least a part of photosensitive pixels (not shown) of the light sensing module 220 can detect the light 231. When a user operates on the second substrate 216, a transmitting path of a part of the light 231 is changed, and thereby some photosensitive pixels originally capable of detecting the light 231 do not detect the light 231 anymore. In such way, the touch position can be calculated according to the photosensitive pixels that have not detect the light 231 because of the operation of the user.

Unlike conventional techniques that the light sensing module is disposed on the entire display unit, the light sensing module 220 and the light source 230 of the present embodiment are directly disposed on the non-display area 213 of the first substrate 212 supporting the display layer 214. Furthermore, an additional transparent substrate disposed between the light sensing module 220 and the display unit 210 is not needed. Therefore, the thickness of the optical touch display device 200 is effectively reduced and the optical touch display device 200 has an advantage of thin thickness.

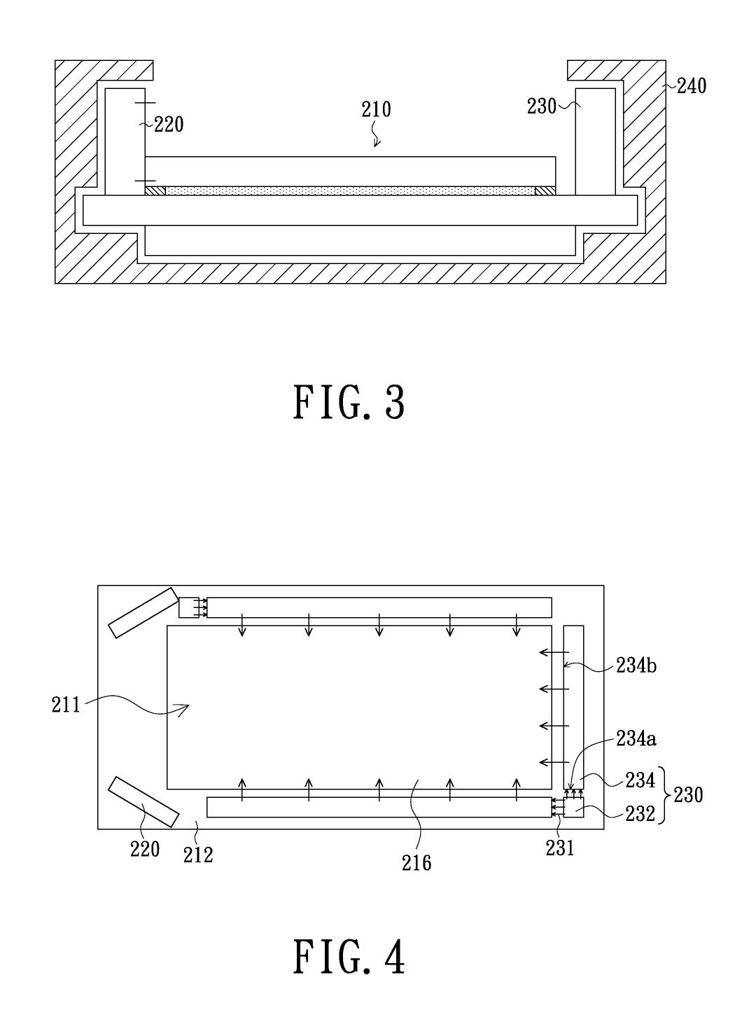

In another embodiment, as shown in FIG. 3, the optical touch display device may further include a frame 240, and the display unit 210 and the light sensing module 220 are partially wrapped in the frame 240.

FIG. 4 is a schematic, top view of an optical touch display device according to another embodiment of the present invention. Referring to FIG. 4, the display area 211 of the present embodiment is, for example, a rectangle. The optical touch display device may include a plurality of the light sensing modules 220 (e.g. two light sensing modules 220), and the light sensing modules 220 are disposed on the corners of the display area 211. In addition, the light source 230 may include at least one light emitting element 232 (two are shown in FIG. 4) and at least one light guiding element 234 (three are shown in FIG. 4). The light emitting element 232 is configured to provide the above-mentioned light 231, and the light guiding element 234 is disposed beside the light emitting element 232. The light guiding element 234 has a light incident surface 234a and a light emitting surface 234b. The light incident surface 234a receives the light 231, and the light 231 is emitted from the light emitting surface 234b and then passes through an area above the display layer (not shown). In an embodiment, the light emitting element 232 is, for example, but not limited, an infrared light emitting element.

In the embodiment shown by FIG. 4, two light sensing modules 220 are taken as an example. In other embodiments, more light sensing modules 220 (such as three or four) can be used according to design requirements, and each light sensing module 220 is, for example, disposed on one of the corners of the display area 211.

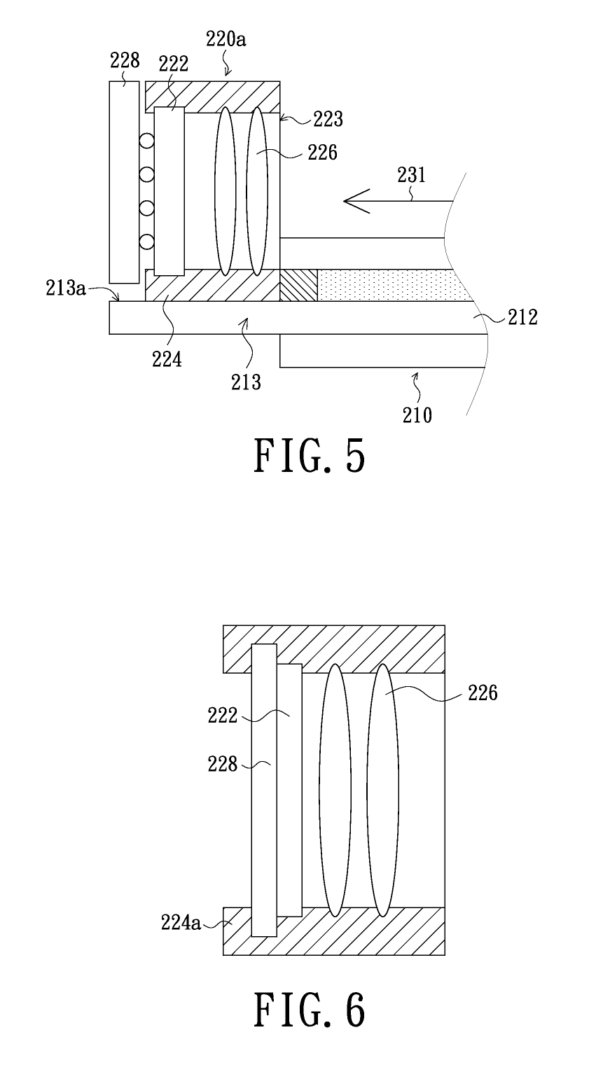

FIG. 5 is a schematic view of an optical touch display device according to another embodiment of the present invention. Referring to FIG. 5, in the present embodiment, a light sensing module 220a includes a sensing unit 222 and a fixing unit 224. The sensing unit 222 is fixed above the non-display area 213 of the first substrate 212 via the fixing unit 224 and the fixing unit 224 elevates the sensing unit 222 to above the display unit 210. Thereby, the sensing unit 222 is capable of detecting the light 231 above the display unit 210 via the at least a portion of the light sensing window 223 and outputting a sensing signal.

In addition, the light sensing module 220a may further include a lens unit 226 and a circuit board 228. The lens unit 226 is capable of condensing the light 231, so that the light 231 entering the light sensing window 223 is provided to the sensing unit 222. The circuit board 228 is electrically connected to the sensing unit 222 and is configured to output the signal corresponding to the sensing signal output by the sensing unit 222. The signal output by the circuit board 228 can be a processed signal. That is, the touch position has been calculated. In another embodiment, the circuit board 228 does not have a function for calculating the touch position. The circuit board 228 only transmits the signal to a processing unit (not shown), and the touch position is calculated by the processing unit In addition, the lens unit 226 and the sensing unit 222 are fixed to the first substrate 212 via the fixing unit 224 and the fixing unit 224 elevates the lens unit 226 and the sensing unit 222 to behind the light sensing window 223. Thereby, the sensing unit 222 is capable of detecting the light 231 passing through the light sensing window 223 and above the display unit 210 via the lens unit 226. In another embodiment, as shown in FIG. 6, the fixing unit 224a may further fix the circuit board 228.

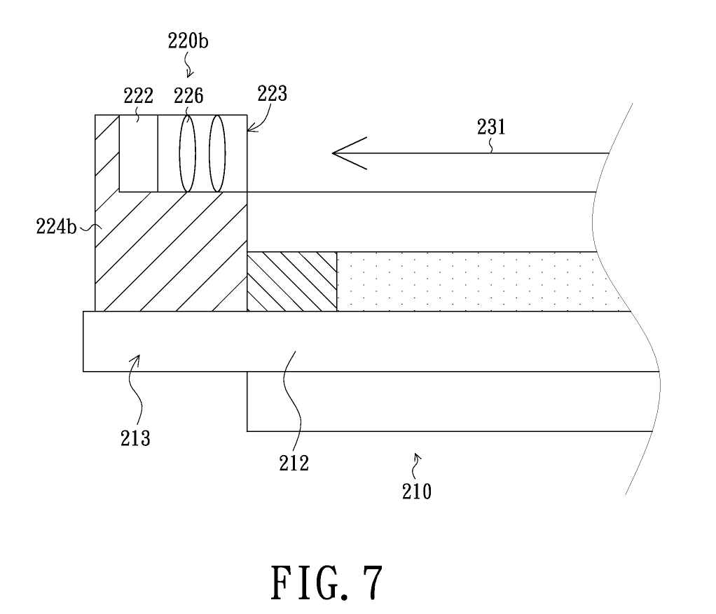

FIG. 7 is a schematic view of an optical touch display device according to another embodiment of the present invention. Referring to FIG. 7, a light sensing unit 220b of an optical touch display device of the present embodiment includes the sensing unit 222, a fixing unit 224b and the lens unit 226. The sensing unit 222 is fixed above the non-display area 213 of the first substrate 212 via the fixing unit 224b, and the fixing unit 224b elevates the entire sensing unit 222 to above the display unit 210. Thereby, the sensing unit 222 is capable of detecting the light 231 above the display unit 210 via the entire light sensing window 223 and outputting the sensing signal. In addition, the light sensing unit 220b of the present embodiment may further include a circuit board (not shown) electrically connected to the sensing unit 222.

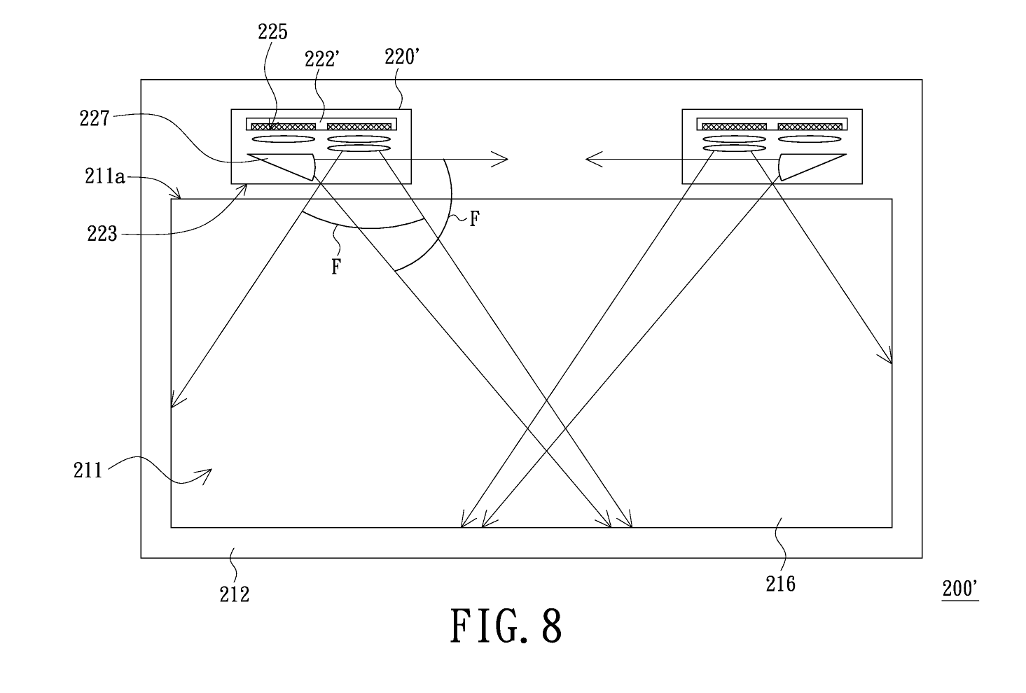

FIG. 8 is a schematic, top view of an optical touch display device according to another embodiment of the present invention. Referring to FIG. 8, two light sensing modules 220′ of an optical touch display device 200′ of the present embodiment are disposed beside a same side 211a of the display area 211, and the light sensing window 223 of each light sensing module 220′ is, for example, parallel to the side 211a of the display area 211. In addition, a sensing unit 222′ of each light sensing module 220′ has a plurality of sensing areas 225, and each sensing area 225 has a field of view F. Each light sensing module 220′ further includes at least one reflecting element 227 disposed in front of at least one of the sensing areas 225 so as to turn the field of view F of the corresponding sensing area 225. The above-mentioned reflecting element 227 is, for example, a prism. The field of view F of the sensing area 225 can be turned via the reflecting element 227, so the light sensing modules 220′ of the optical touch display device 200′ can be disposed on the same side 211a of the display area 211. In such way, the positions of the light sensing modules 220′ are more flexible.

It should be noted that, although a light source is omitted in FIG. 8, the optical touch display device 200′ of the present embodiment can also include a light source. Additionally, the present invention does not limit a number of the light sensing modules 220′, and the light sensing modules 220′ can also be disposed on two opposite sides of the display area 211.

In summary, the optical touch display device of each embodiment of the present invention at least has one of the following advantages:

1. In the present invention, the light sensing module is disposed on the first substrate supporting the display layer, but is not disposed on the entire display unit. Furthermore, compared to the conventional techniques, the light sensing module of the present invention omits a transparent substrate disposed above the display unit. Therefore, the optical touch display device of the present invention has a thin thickness.

2. In an embodiment, the reflecting element is disposed in front of one of the sensing areas of the light sensing module, so the field of view of the sensing area can be turned by the reflecting element. Therefore, the positions of the light sensing modules are more flexible.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An optical touch display device comprising:
a display unit comprising a first substrate and a display layer, the first substrate having a display area and a non-display area surrounding the display area, and the display layer being disposed on the display area of the first substrate; and
at least one light sensing module disposed on an upper surface of the non-display area of the first substrate, a side surface of the light sensing module having a light sensing window, and at least a portion of the light sensing window being adapted to receive light above the display unit.

2. The optical touch display device according to claim 1, wherein the light sensing module comprises a sensing unit and a fixing unit, the sensing unit is fixed above the non-display area of the first substrate via the fixing unit, the fixing unit elevates the sensing unit to above the display unit, and thereby the sensing unit is capable of detecting the light above the display unit via the at least a portion of the light sensing window and outputting a sensing signal.

3. The optical touch display device according to claim 1, wherein the side surface having the light sensing window abuts the display layer, and the side surface having the light sensing window and the light sensing window are perpendicular to the first substrate.

4. The optical touch display device according to claim 2, wherein the light sensing module further comprises:
a lens unit configured to provide the light from the light sensing window to the sensing unit; and
a circuit board electrically connected to the sensing unit and configured to output the sensing signal output by the sensing unit, the lens unit and the sensing unit are fixed to the first substrate via the fixing unit, the fixing unit elevates the lens unit and the sensing unit to behind the light sensing window, and thereby the sensing unit is capable of detecting the light passing through the light sensing window and above the display unit via the lens unit.

5. The optical touch display device according to claim 4, wherein the fixing unit further fixes the circuit board.

6. The optical touch display device according to claim 1, comprising a plurality of the light sensing modules, wherein the display area is a rectangle, and the light sensing modules are respectively disposed on corners of the display area.

7. The optical touch display device according to claim 2, wherein the sensing unit has a plurality of sensing areas, each sensing area has a field of view, the light sensing module further comprises at least one reflecting element disposed in front of at least one of the sensing areas so as to turn the field of view of the corresponding sensing area.

8. The optical touch display device according to claim 7, wherein the reflecting element comprises a prism.

9. The optical touch display device according to claim 1, further comprising a light source disposed on the non-display area of the first substrate and configured to provide the light passing through an area above the display layer to the light sensing module.

10. The optical touch display device according to claim 9, wherein the light source further comprises:
at least one light emitting element configured to provide the light; and
at least one light guiding element disposed beside the light emitting element, the light emitting element having a light incident surface and a light emitting surface, the light incident surface being configured to receive the light, and the light being emitted from the light emitting surface.

11. The optical touch display device according to claim 10, wherein the light emitting element comprises an infrared light emitting element.

12. The optical touch display device according to claim 1, further comprising a frame, wherein the display unit and the light sensing module are partially wrapped in the frame.

13. The optical touch display device according to claim 1, wherein the display unit further comprises:
a second substrate opposite to the first substrate, and the display layer being disposed between the first substrate and the second substrate; and
a plurality of spacers disposed between the first substrate and the second substrate.

14. The optical touch display device according to claim 1, wherein the display unit further comprises a backlight source disposed under the first substrate.

15. The optical touch display device according to claim 1, wherein the display unit comprises a liquid crystal display unit, a bistable display unit, an organic light-emitting diode display unit, an electrowetting display unit or a plasma display unit.
